(19) United States
(12) Patent Application Publication
(10) Pub. No.: US 2007/0295755 A1
(43) Pub. Date: Dec. 27, 2007

(54) Programmable Dispensing Apparatus

(76) Inventors: Robert Kinzie, Shreveport, LA (US); Layton J. Reprogle, Wentzville, MO (US); Layton T. Reprogle III, O'Fallon, MO (US); Stephen M. Reprogle, Wentzville, MO (US)

Correspondence Address: SPENCER FANE BRITT & BROWNE LLP, 1 NORTH BRENTWOOD BLVD., SUITE 1000, ST. LOUIS, MO, 63105-3925, US

(21) Appl. No.: 11/575,624

(22) PCT Filed: Sep. 26, 2005
(86) PCT No.: PCT/US05/34274

§ 371 Date: Mar. 20, 2007

Related U.S. Application Data
(60) Provisional application No. 60/613,019, filed on Sep. 24, 2004.

(51) Int. Cl. G01F 11/20; G01F 11/10

(52) U.S. Cl. 222/239; 222/242; 222/370

(57) ABSTRACT

An apparatus for dispensing a flowable material in a predetermined amount includes a metering wheel member (22) for delivery of the flowable material from a supply reservoir (12) to a dispensing port (28). The apparatus includes an agitator assembly (52) mounted within the supply reservoir (12) to maintain and promote flow of the material to be dispensed. A motive power source (30) is provided to effect rotation of the metering wheel member (22) and agitator assembly (52) within the supply reservoir (12). Another embodiment further provides a liquid supply system (84) for introducing liquid for rinsing or mixing. The apparatus may be further contained within a cabinet (68) for security and maintenance.

### CROSS REFERENCE TO RELATED APPLICATIONS

This application claims priority benefit from U.S. provisional patent application Ser. No. 60/613,019, filed Sep. 24, 2004.

### BACKGROUND OF THE INVENTION

The present invention relates generally to an apparatus for dispensing a flowable material. More particularly, the invention is directed to an apparatus for dispensing a flowable material in a predetermined amount at a predetermined rate and time. The invention has particular application to environments requiring the distribution of an agent to an end destination, such as to drains and grease traps in restaurants and the like.

Drains in kitchen sinks in institutional settings such as restaurants and cafeterias receive a number of different substances, ranging from consumables, such as food, organic material and liquids, to chemicals and waste products. Being subject to such a wide variety of matter and accumulation of organic waste, drain sinks and grease traps are a fertile breeding ground for bacterial growth. While treatment agents are available and can be quite effective, their effectiveness is dependent upon the diligence of kitchen personnel in applying the agents. Frequently, such diligence is lacking, and treatments are forgotten or the wrong amount is applied. Even where workers are diligent, a treatment may require periodical and sequential application of agents over the course of a night. In such situations, workers may not be present for the entire period to apply the agents to the drain for effective treatment.

Accordingly, there is a need for an apparatus which is able to deliver a material to a drainage destination where the amount of material delivered can be controlled. There is also a need for such an apparatus that can deliver the material at a controlled rate. Moreover, it would be desirable for such apparatus to perform such functions without constant human attention.

### BRIEF SUMMARY OF THE INVENTION

An object of the present invention is to provide an apparatus by which a solid material in powdered or granulated form can be dispensed into a mixing vessel or piping conduit in a controlled quantity over a controlled time interval.

In order to achieve the above object of the invention, there is provided a material dispensing apparatus comprising a supply reservoir for containing the powdered or granulated solid material to be dispensed. A conveyor comprising a metering wheel member having a plurality of chambers receives material from the supply reservoir and carries it on for dispensing from the apparatus. The chambers are of a fixed dimension so that they carry a predetermined amount of material therein. The metering wheel is attached to a rotatable shaft which enables the material to be conveyed to a dispensing port towards the bottom of the apparatus. A separator plate is positioned between the supply reservoir and the metering wheel to control the flow of material from the supply reservoir to the metering wheel. A motor source is provided to power the rotation of the shaft and metering wheel. An electronic controller is provided for controlling the occurrence and rate at which the metering wheel rotates, which affects the timing, rate and amount of material dispensed from the apparatus.

In accordance with another embodiment of the invention, an agitator assembly is mounted in the supply reservoir to promote flow of the material to be dispensed. The agitator assembly is comprised of members which rotate through the material to mix the material, break up clumps of powder and scrape the material into the metering wheel.

In accordance with another embodiment of the invention, a post-dispensing chamber in which dispensed material is deposited is provided. This chamber enables material received from multiple dispensing units to be mixed, such as when two different component materials are required to be combined. Further, a liquid supply source may be provided for injecting a liquid, such as water, into the post-dispensing chamber. The introduction of water into the post-dispensing chamber may be for the purpose of creating a slurry of the dispensed material, to promote flow of powdered material to the drainage destination, or to rinse the chamber of residual material particles.

Another embodiment of the invention comprises a cabinet in which the dispensing apparatus is housed. The cabinet may be equipped with lockable doors to provide security and limit access to the dispensing apparatus.

Accordingly, it is an object of the present invention to provide an improved apparatus for dispensing a flowable material in a controlled quantity over a controlled time interval. There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention. Though some features of the invention may be claimed in dependency, each feature has merit when used independently.

### BRIEF DESCRIPTION OF THE DRAWINGS

Further features of the present invention will become apparent to those skilled in the art to which the present invention relates from reading the following description with reference to the accompanying drawings, in which:

FIG. 1 is a perspective view illustrating an embodiment of the invention.

FIG. 2 is a top plan view of the apparatus shown in FIG. 1.

FIG. 3 is a fragmentary perspective view of the mounted motor and drive shaft of one embodiment of the dispensing unit.

FIG. 4 is a fragmentary perspective view of the base portion of one embodiment of the dispensing unit.

FIG. 5 is a fragmentary perspective view of the metering wheel member as mounted on the base portion of one embodiment of the dispensing unit.

FIG. 6 is a fragmentary perspective view of an embodiment of the agitator assembly and metering wheel member as mounted on the base portion of one embodiment of the dispensing unit.

FIG. 7 is a perspective view of the cabinet housing an embodiment of the dispensing system of the invention.

FIG. 8 is a view in side elevation from the front of the cabinet housing shown in FIG. 7.

FIG. 9 is a cross-sectional view in side elevation of the post-dispensing chamber according to an alternative embodiment of the invention.

### DETAILED DESCRIPTION OF THE INVENTION

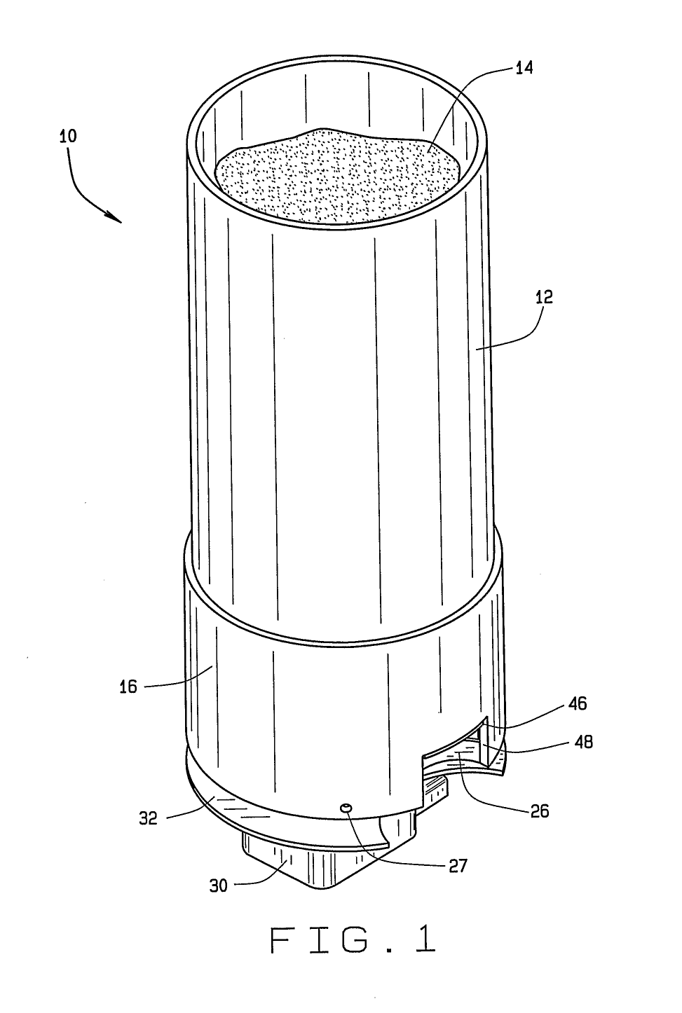

A preferred embodiment of the dispensing apparatus 10 of the present invention is generally shown in FIG. 1. The dispensing apparatus has a supply reservoir 12 having an internal dimension sufficient to hold a quantity of flowable material 14. The material that can be dispensed by the present invention comprises any solid that is able to flow to a certain degree, and can comprise grains, powder, pellets and the like. The volume capacity of supply reservoir 12 may vary depending upon the particular application for which the dispensing apparatus is employed, and can range from a relatively small volume capacity on the order of a few liters for dispensing flowable material into a drain, to a substantially large volume capacity for industrial applications. Supply reservoir 12 may comprise substantially the entire body of the dispensing apparatus, or, alternatively, may comprise a separate container connected to a lower housing 16 as shown in FIG. 1.

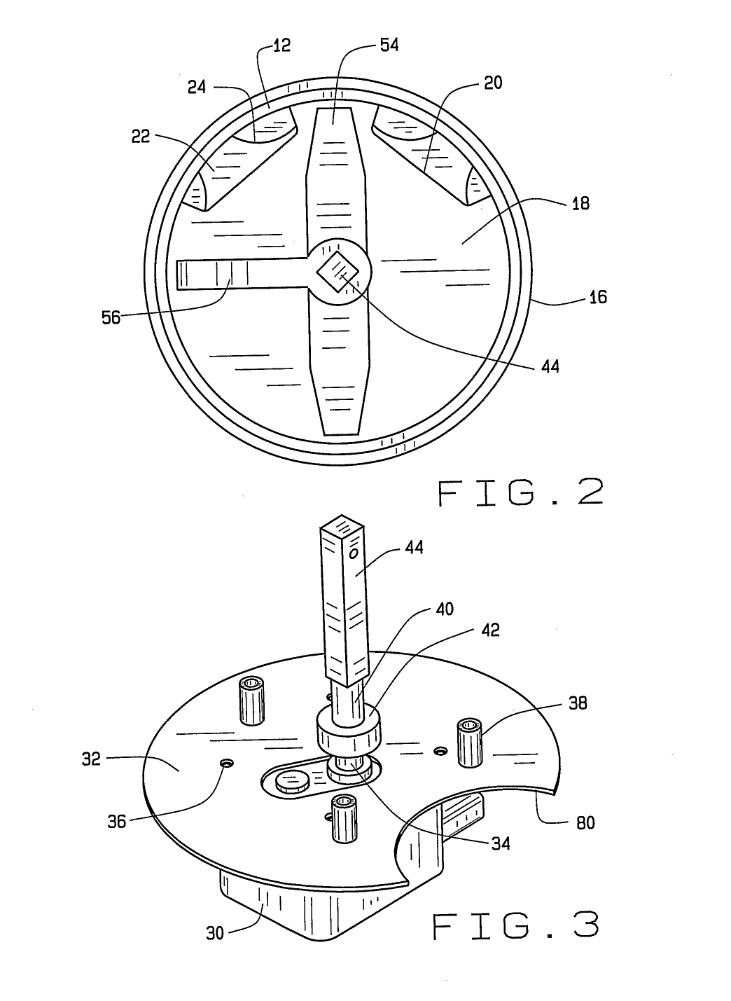

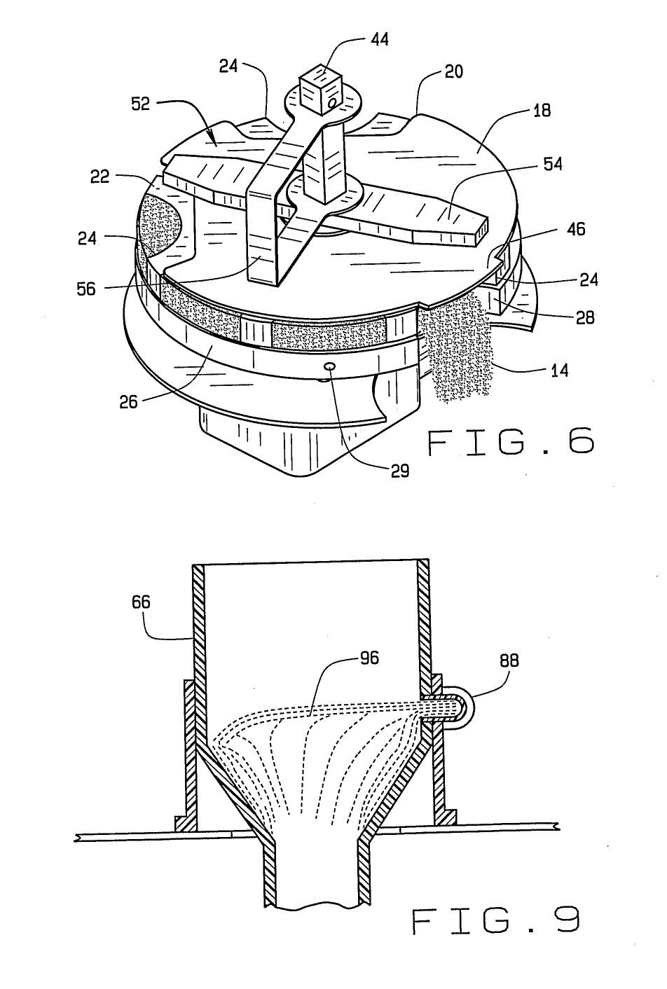

A separator plate member 18 is disposed in the apparatus below supply reservoir 12, as seen in FIG. 2, which serves to prevent flowable material from being prematurely dispensed from the apparatus. One or more openings 20 are provided in separator plate member 18 to permit flowable material to drop from supply reservoir 12 to regions below where it will be conveyed and dispensed further. A carrier is positioned below the supply reservoir to convey the flowable material on for dispensing. Flowable material that passes through openings 20 is deposited onto metering wheel member 22 as shown in FIG. 6. A plurality of apertures 24 are disposed in wheel member 22 and receive the flowable material that passes down through openings 20. A base plate 26 is positioned below metering wheel member 22 as shown in FIG. 5 which serves as a bottom floor to retain flowable material within apertures 24 as the apertures are filled. Apertures 24 are formed of specific dimensions so that a volume of flowable material conveyed by the metering wheel are of a predefined and consistent value. In the metering wheel shown in the drawings, each aperture 24 has a consistent arc shape which represents a certain predetermined area. The aperture's inner perimeter boundary is formed in the metering wheel itself, and the aperture's outer boundary is defined by the wall of the supply reservoir 12 as shown in FIG. 2. The bottom boundary of each aperture 24 is formed by the base plate 26 and, as metering wheel 22 rotates, and the aperture moves out of registry with opening 20, the top boundary is formed by the separator plate 18 as shown in FIG. 6. The enclosed area in the aperture 24 thus represents a predetermined volume corresponding to a measured amount of flowable material to be dispensed. The volume can be adjusted in a number of ways, including varying the area of apertures 24 or the width of metering wheel 22. Increasing either of these dimensions provides a corresponding increase in volume. Similarly, the placement of apertures 24 may be varied, and can be disposed in the metering wheel such that the apertures are completely enclosed within the body of the metering wheel.

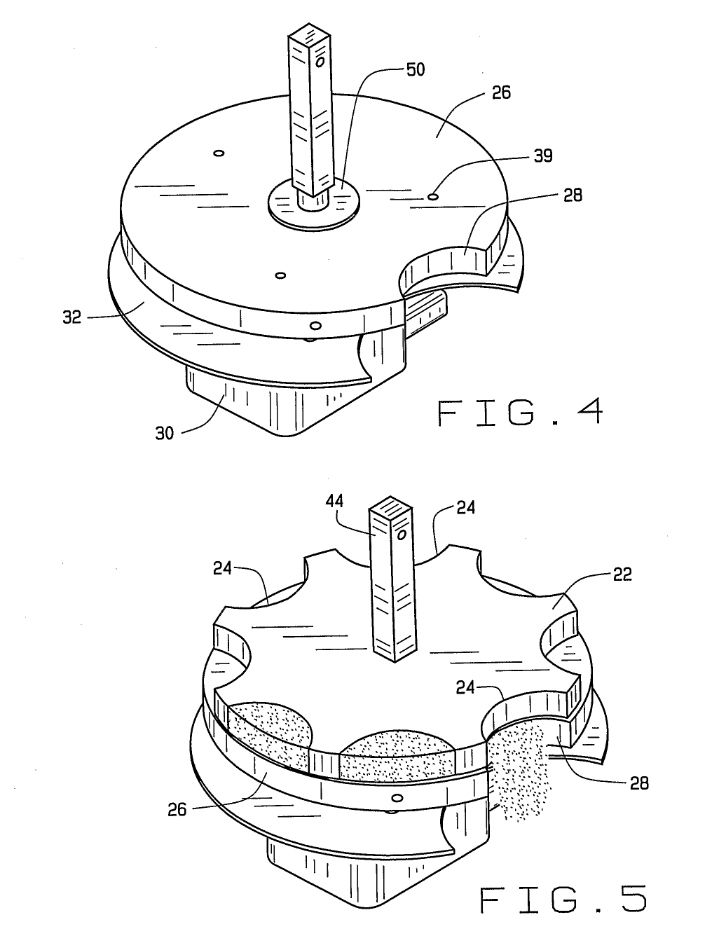

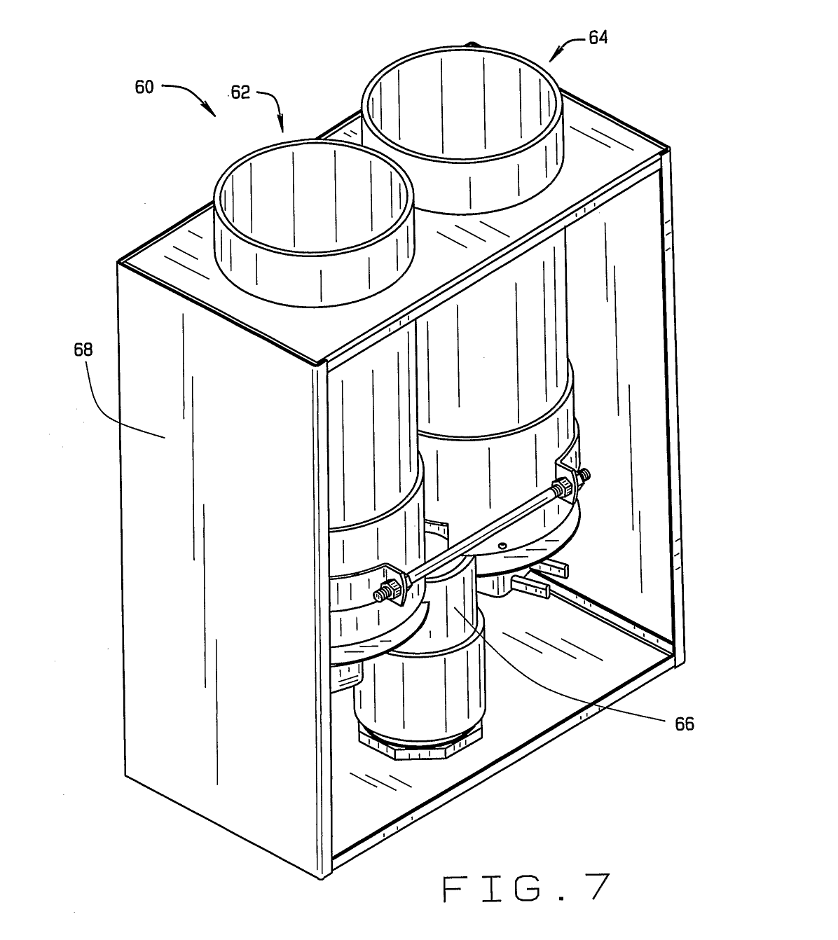

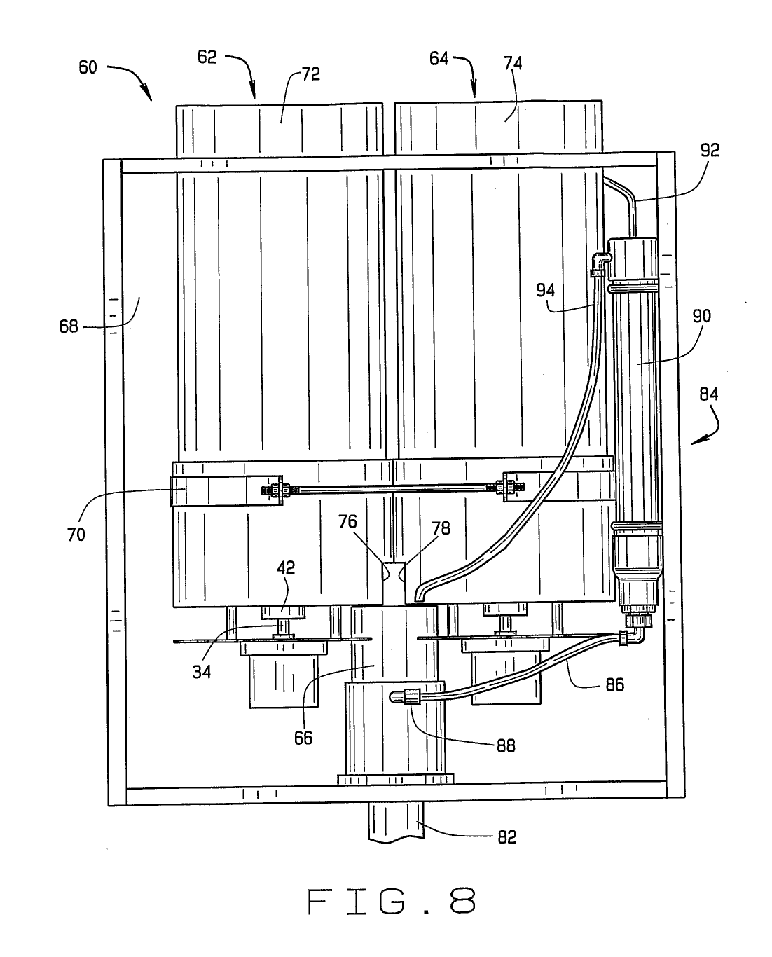

Flowable material is dispensed from the apparatus through dispensing port 28, which comprises an opening formed into base plate 26 as shown in FIG. 4. The flowable material 14 held within apertures 24 is conveyed for dispensing by rotation of metering wheel 22 such that each filled aperture is brought into alignment with dispensing port 28 as shown in FIG. 6. The openings 20 in separator plate 18 should be positioned remotely from dispensing port 28 to prevent premature discharge of flowable material from the supply reservoir. A motor 30 is provided for driving metering wheel 22. Motor 30 is mounted underneath plate 32 as shown in FIG. 3. Motive power is translated by drive axle 34 which extends through plate 32 upward from motor 30 as shown in FIG. 8. The speed of the motor is governed by an electronic controller (not shown) of any suitable type known to those skilled in the art. The volume of total material dispensed by the apparatus is a function of the rate at which the motor rotates the metering wheel. The controller can be programmed to vary the output of the motor to control the rate of rotation of the metering wheel and the timing of when the metering wheel is rotated. Drive shaft 40 is mounted to drive axle 34 by connection bushing 42 as shown in FIG. 3 and extends upward through base plate 26 for operative engagement with metering wheel 22 as shown in FIG. 5. Mounting plate 32 is of sufficient strength and durability to support motor 30 and provide a mounting base for the dispensing apparatus as shown in FIG. 8. A series of mounting screw channels 36 receive fasteners to enable motor 30 to be mounted and secured to plate 32 as shown in FIG. 3. A plurality of bushings 38 provide spacing between mounting plate 32 and base plate 26 as shown in FIG. 8. Fastening members (not shown) pass through holes 39 in base plate 26, as shown in FIG. 4, and pass through bushings 38 to engage mounting plate 32.

A lower end of drive shaft 40 is cylindrical and passes through a central circular opening in base plate 26 enabling it to rotate freely therein as shown in FIG. 4. Base plate 26 can be held stationary in the apparatus by affixing it within lower housing 16 by fastening members received, for example, through a plurality of holes 27 in lower housing 16 as shown in FIG. 1 and holes 29 in base plate 26 as shown in FIG. 6. Alternately, base plate 26 can be made to be integral with the housing. An upper end 44 of drive shaft 40 has a square, or other non-cylindrical, cross section as shown in FIG. 3. The central aperture of metering wheel 22 has a shape approximating the cross sectional shape of upper drive shaft end 44 for operative engagement as shown in FIG. 5, and the metering wheel is accordingly rotated as drive shaft 40 turns. Thus metering wheel 22 rotates while base plate 26 remains stationary. In this fashion, flowable material 14 in each wheel aperture 24 is conveyed by metering wheel 22 over stationary base plate 26, as shown in FIG. 6. Separator plate 18 should also remain stationary with respect to the rotation of metering wheel 22. Therefore, the central aperture through separator plate 18 should be large enough to permit non-cylindrical shaft upper end 44 to rotate freely therein without engagement of the plate. A tab 46 extends from the edge of separator plate 18, as shown in FIG. 6, which is designed to engage the wall of the apparatus to hold separator plate 18 stationary during rotation of drive shaft 44. Gap 48 is provided in the wall of lower housing 16 as shown in FIG. 1 to receive tab 46, thus holding separator plate 18 stationary. As an alternative arrangement to maintain separator plate 18 stationary with respect to metering wheel 22, that portion of drive shaft 40 passing through separator plate 18 maybe made to be cylindrical, so that it can rotate freely through its central aperture.

While the space between metering wheel 22 and base plate 26 and that between metering wheel 22 and separator plate 18 should be kept as minimal as possible to enable the metering wheel to effectively convey flowable material, a slight gap may nonetheless be provided to prevent binding or excessive friction. As shown in FIG. 4, washer 50 is disposed on base plate 26 to provide a slight gap underneath metering wheel 22. The washer is comprised of any material, such as a plastic, which has friction-limiting properties. The thickness of the washer should be kept to a minimum, such as around 0.0625 inches. A similar washer 58 may also be placed between metering wheel 22 and separator plate 18.

Flowable material 14, if in powder form, may occasionally be clumpy or somewhat resistant to flow. The apparatus is provided with an agitator assembly 52, as shown in FIG. 6, which mixes the flowable material in the supply reservoir to promote flow. One embodiment of the agitator assembly comprises stripper bar 54 and sweeper arm 56, each being mounted on upper drive shaft 44. Stripper bar 54 has a diameter closely approximating the inner diameter of supply reservoir 12 in order to extend to and reach over the openings 20 in separator plate 18 and apertures 24 in metering wheel 22. It is spaced slightly above separator plate 18 and sits on washer 58. As the drive shaft turns metering wheel 22, upper drive shaft 44 rotates stripper bar 54 which scrapes flowable material into openings 20 which then falls down into apertures 24. Sweeper arm 56 is generally U-shaped and extends radially from drive shaft 44. The legs of sweeper arm 56 terminate in openings approximating the cross-sectional shape of drive shaft 44 for engagement therewith so that the rotation of the drive shaft translates into rotation of the sweeper arm. It likewise rotates as metering wheel 22 turns, and mixes the flowable material to break up clumps and urge material downwardly towards the bottom of the supply reservoir. The mixing effect can be enhanced by mounting stripper bar 54 and sweeper arm 56 in an offset arrangement as shown in FIG. 6. If desired, a plurality of each of stripper bars 54 and sweeper arms 56 may be mounted within the apparatus. Gap 48 in lower housing 16, as shown in FIG. 1, provides an enlarged opening to further facilitate discharge of the material from dispensing port 28.

Dispensing apparatus 10 may be arranged so that flowable material is dispensed directly into a drainage destination, such as a sink. It may be desirable to provide alternative dispensing arrangements, where the dispensed material is conveyed to a separate intermediate vessel as further described herein below. FIGS. 7 and 8 show a multi-unit dispensing apparatus 60 comprising a pair of dispensing units 62 and 64 which dispense material into a post-dispensing vessel 66. Each dispensing unit 62 and 64 comprise similar structure and elements as that described above for dispensing apparatus 10. A cabinet 68 is provided for housing and supporting multi-dispensing apparatus 60. Mounting bracket 70 holds supply reservoirs 72 and 74 in place side-by-side within cabinet 68 such that their respective dispensing ports 76 and 78 discharge into post-dispensing vessel 66. Given the myriad applications for which the dispensing apparatus of the present invention can be utilized, post-dispensing vessel 66 is adaptable to provide a number of functions. In its simplest form, vessel 66 serves as a common receiving conduit for multiple dispensing units. As shown in FIG. 8, supply reservoirs 72 and 74 are mounted such that their cylindrical bodies overlap into the space over vessel 66, permitting simple, vertical gravity flow of material out of dispensing ports 76 and 78 into vessel 66. In order to permit this overlapping arrangement, mounting plate 32 of each dispensing unit is provided with a recessed portion 80, as shown in FIG. 3. The dimension of recessed portion 80 is sufficient to receive a portion of vessel 66 therein as shown in FIG. 8. This arrangement places dispensing port of each dispensing unit directly over vessel 66 to receive discharged material. In this fashion, only one dispensing conduit 82 need be used to convey flowable material to the end destination.

Post-dispensing vessel 66 also serves as a rinsing chamber to ensure that flowable material is efficiently carried to its drainage destination. As suggested above, flowable material may sometimes be clumpy or not overly conducive to free flow. Accordingly, a liquid supply 84, such as water, may be necessary to be injected into the discharged material to promote flow. Liquid supply line 86 feeds in to vessel 66 through fitting 88 as shown in FIGS. 8 and 9. The liquid supply may be configured to be injected under pressure, or to be supplied in controlled amounts. Fluid regulator 90 is mounted in cabinet 68 which controls the flow of water into vessel 66. In dispensing environments where a protected water supply 92 feeds into the system, such as that in food preparation environments, a vacuum relieving line 94 is provided to prevent aspiration of water back into the water supply. In instances where it is desirable to rinse residual particles from vessel 66, sufficient pressure may be introduced to the liquid supply to create a stream 96 of adequate force to traverse vessel 66 as shown in FIG. 9. Further, appropriate nozzle attachments may be employed on fitting 88 to widen the dispersed spray so that a thorough rinsing action may be imparted to the interior of vessel 66. The bottom of vessel 66 can be funnel-shaped to enhance the rinsing effect and promote drainage.

Post-dispensing vessel 66 may also serve as a mixing chamber to produce a slurry from the flowable material utilizing the liquid supply arrangement described above. Also, the respective supply reservoirs can be filled with different materials, whose combination in the post-dispensing vessel 66 creates a resultant composition having desired properties. Appropriate circuitry can be provided for controlling respective operation of the motors driving the dispensing units and the liquid supply source. The rate, timing and duration that each material is dispensed from its respective unit can thereby be controlled as necessary.

Cabinet 68 may be provided with doors or other shutter members (not shown) which may be locked to prevent unauthorized access to the system or disruption of the dispensing operation. The dispensing apparatus may be mounted in the cabinet to permit limited access, such as for filling the supply reservoir from the top as shown in FIG. 7.

The dispensing apparatus of the invention is particularly useful for dispensing predetermined amounts of powdered or granular materials, such as drain, grease trap, and septic system treating materials, to aid in digestion of organic waste. Although an example of the motive power source is shown using an electric motor, it will be appreciated that other motive power sources can be used, including hydraulic motors for example. Also, although the dispensing apparatus is useful to dispense waste treatment additives into drains, grease traps, and septic systems, it can also be used for dispensing other types of flowable materials for various applications in, for example, the agriculture and chemical industries.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. An apparatus for dispensing a predetermined amount of a flowable material, the apparatus comprising:
a supply reservoir;
a measuring conveyor;
a measuring conveyor closing member;
a dispensing port; and
a motive power source,
the supply reservoir being adapted to store a quantity of flowable material, the supply reservoir being further adapted for communication with the measuring conveyor for introduction of flowable material thereto, the measuring conveyor comprising a dimension and volume corresponding to a predetermined amount of flowable material, the measuring conveyor and measuring conveyor closing member being movable relative to the other, the measuring conveyor being adapted to be cut off from communication with the supply reservoir by effecting a change of relative position between the measuring conveyor and the measuring conveyor closing member, the motive power source being adapted to effect relative movement between the measuring conveyor and the measuring conveyor closing member, the measuring conveyor being further adapted for communication with the dispensing port through which flowable material is dispensed from the apparatus.

2. The apparatus of claim 1 in which the measuring conveyor is comprised of a carrier member having multiple measuring compartments, the carrier member being moveable relative to the dispensing port, the motive power source being adapted to effect relative movement between the carrier member and the dispensing port to sequentially bring each measuring compartment into communication with the dispensing port.

3. The apparatus of claim 2 in which the supply reservoir is comprised of a cylindrical supply reservoir, the carrier member comprising a wheel member rotatably disposed within the cylindrical supply reservoir, the multiple measuring compartments being disposed around a periphery of the wheel member, each measuring compartment having an internal area defining a volume corresponding to the predetermined amount of flowable material, the motive power source effecting rotational movement of the wheel member to sequentially bring each measuring compartment into communication with the dispensing port.

4. The apparatus of claim 1 in which an agitator member is disposed within the supply reservoir, the agitator member being adapted to stir the flowable material stored in the supply reservoir.

5. The apparatus of claim 2 in which an agitator member is disposed within the supply reservoir, the agitator member being adapted to stir the flowable material stored in the supply reservoir, the motive power source being adapted to actuate the agitator member.

6. The apparatus of claim 3 further comprising a base portion, the dispensing port being disposed in the base portion, the wheel member being disposed above the base portion, the wheel member being rotatable relative to the base portion, the measuring conveyor closing member comprising a plate member, the plate member being disposed above the wheel member, the wheel member being rotatable relative to the plate member, the base portion, wheel member and plate member each having a dimension approximating the cross-sectional area of the cylindrical supply reservoir to effectively seal off the flowable material from passing through the supply reservoir to the dispensing port other than through the wheel member, at least one opening being formed in the plate member at a position remote from the dispensing port, the volume corresponding to the predetermined amount of flowable material being defined by the internal area of any one wheel member measuring compartment as bounded on its lower edge by the base portion and its upper edge by the plate member, the flowable material being adapted for flow into the wheel member measuring compartment by passing through the plate member by way of the at least one opening therein, the motive power source having a rotatable shaft for translating motive power, the power source being positioned in proximity to the base portion such that the rotatable shaft passes through the base portion to operatively engage the wheel member, the apparatus being adapted for multiple, sequential dispensing of predetermined amounts of flowable materials by effecting rotation of the wheel member by the power source to bring the measuring compartments into communication with the at least one opening in the plate member, permitting flowable material from the supply reservoir to be deposited in the measuring compartment, and further effecting rotation of the wheel member by the power source to bring the measuring compartments into communication with the dispensing port, permitting flowable material to be dispensed from the apparatus.

7. The apparatus of claim 6 in which an agitator member is operatively engaged with the rotatable shaft of the power source, the agitator member being thereby adapted to stir the flowable material stored in the supply reservoir upon operation of the power source.

8. An apparatus for dispensing a predetermined amount of a flowable material over a predetermined time interval, the apparatus comprising:
a supply reservoir;
a metering wheel member;
a separator plate member;
a dispensing port; and
a motive power source,
the supply reservoir comprising a cylindrical container adapted to store a quantity of flowable material, the metering wheel member being horizontally disposed within the supply reservoir towards a lower end thereof and being operatively engaged with the motive power source for rotation at a predetermined rate, a circumferential edge of the metering wheel abutting an interior wall of the supply reservoir in rotational relationship, the metering wheel defining at least one aperture adapted to receive therein a quantity of the flowable material, the metering wheel being disposed above a base surface, the metering wheel lying in close proximity to the base surface and being rotatable with respect thereto, the separator plate member being fixedly disposed above the metering wheel member and defining an opening through which flowable material may flow from the supply reservoir, the dispensing port being disposed below the metering wheel at a location remote from the opening in the separator plate member, whereby an amount of flowable material is able to pass from the supply reservoir through the opening of the separator plate member to fill the aperture in the metering wheel member, the metering wheel member being adapted to be rotated to move the filled aperture out of registry with the opening in the separator plate member whereby a closed space chamber of specific dimension corresponding to a volume of the predetermined amount of the flowable material may be created, the specific dimension comprising the volume being defined by the edges of the aperture in the metering wheel member, the base surface below the metering wheel member, and the separator plate member above the metering wheel member, the predetermined volume of material being adapted to be conveyed to the dispensing port by rotation of the metering wheel member.

9. The apparatus of claim 8 in which the metering wheel member defines a plurality of apertures adapted to receive a quantity of flowable material, the plurality of apertures being radially arranged around the metering wheel member.

10. The apparatus of claim 9 in which the plurality of apertures defined in the metering wheel member open into a perimeter of the metering wheel member, the specific dimension comprising the volume being further defined by a boundary formed by a wall of the supply reservoir against which the plurality of apertures abut, the dispensing port being defined within the base surface and being disposed at a perimeter thereof, the dispensing port being open at a lateral edge of the base surface, a portion of the wall of the supply reservoir defining an opening in alignment with the dispensing port, the opening in the wall of the supply reservoir being below the separator plate member, the opening being adapted to facilitate discharge of the flowable material through the dispensing port.

11. The apparatus of claim 8 in which the predetermined amount of flowable material to be dispensed is adjusted by varying a thickness of the metering wheel member.

12. The apparatus of claim 8 in which the predetermined amount of flowable material to be dispensed is varied by adjusting a rate of rotation of the metering wheel member.

13. The apparatus of claim 8 in which the predetermined amount of flowable material to be dispensed is adjusted by varying a thickness of the metering wheel member and adjusting a speed of rotation of the metering wheel member.

14. An apparatus for dispensing a predetermined amount of a flowable material over a predetermined time interval, the apparatus comprising:
a supply reservoir;
a metering wheel member;
a separator plate member;
an agitator assembly;
a dispensing port; and
a motive power source,
the supply reservoir comprising a cylindrical container adapted to store a quantity of flowable material, the metering wheel member being horizontally disposed within the supply reservoir towards a lower end thereof and being operatively engaged with the motive power source for rotation at a predetermined rate, a circumferential edge of the metering wheel abutting an interior wall of the supply reservoir in rotational relationship, the metering wheel defining at least one aperture adapted to receive therein a quantity of the flowable material, the metering wheel being disposed above a base surface, the metering wheel lying in close proximity to the base surface and being rotatable with respect thereto, the separator plate being fixedly disposed above the metering wheel member and defining an opening through which flowable material may flow from the supply reservoir, the agitator assembly being disposed above the separator plate member and operatively engaged with the motive power source, the dispensing port being disposed below the metering wheel at a location remote from the opening in the separator plate, whereby an amount of flowable material is able to pass from the supply reservoir through the opening of the separator plate member to fill the aperture in the metering wheel member, the metering wheel member being adapted to be rotated to move the filled aperture out of registry with the opening in the separator plate member whereby a closed space chamber of specific dimension corresponding to a volume of the predetermined volume of the flowable material may be created, the specific dimension comprising the volume defined by the edges of the aperture in the metering wheel member, the base surface below the metering wheel member, and the separator plate above the metering wheel member, the predetermined volume of material being adapted to be conveyed to the dispensing port by rotation of the metering wheel member, the agitator member being adapted to be rotated to stir the flowable material stored in the supply reservoir.

15. The apparatus of claim 14 in which the aperture defined in the metering wheel member is unbounded by the metering wheel member at a perimeter thereof, the specific dimension comprising the volume being further defined by a boundary formed by the wall of the supply reservoir against which the aperture abuts, the dispensing port being defined within the base surface and being disposed at a perimeter thereof, the dispensing port being open at a lateral edge of the base surface, a portion of the wall of the supply reservoir defining an opening in alignment with the dispensing port, the opening in the wall of the supply reservoir being below the separator plate member, the opening being adapted to facilitate discharge of the flowable material through the dispensing port.

16. The apparatus of claim 14 in which the agitator assembly is comprised of a mixing arm member and a stripper bar member, the mixing arm member being spaced apart from the separator plate member, and the stripper bar member being positioned adjacent to the separator plate member.

17. The apparatus of claim 16 in which the motive power source has a rotatable shaft for translating motive power, the power source being positioned in proximity to the base surface such that the rotatable shaft passes through the base surface to operatively engage the wheel member and the agitator assembly.

18. The apparatus of claim 17 in which the mixing arm member and the stripper bar member are mounted at offset positions with respect to each other on the rotatable shaft whereby effective mixing of the flowable material within the supply reservoir is promoted.

19. An apparatus for dispensing a predetermined amount of a flowable material over a predetermined time interval, the apparatus comprising:
a supply reservoir;
a measuring conveyor;
a measuring conveyor closing member;
a dispensing port;
a post-dispensing vessel;
a liquid supply source; and
a motive power source,
the supply reservoir being adapted to store a quantity of flowable material, the supply reservoir being further adapted for communication with the measuring conveyor for introduction of flowable material thereto, the measuring conveyor comprising a dimension and volume corresponding to a predetermined amount of flowable material, at least one of the measuring conveyor and measuring conveyor closing member being movable relative to the other, the measuring conveyor being adapted to be cut off from communication with the supply reservoir by effecting a change of relative position between the measuring conveyor and the measuring conveyor closing member, the motive power source being adapted to effect relative movement between the measuring conveyor and the measuring conveyor closing member at a predetermined rate, the measuring conveyor being further adapted for communication with the dispensing port through which flowable material is dispersed, the flowable material first passing through the post-dispensing vessel prior to being dispensed from the apparatus, the liquid supply source being operatively connected to the post-dispensing vessel.

20. The apparatus of claim 19 in which the post-dispensing vessel comprises a rinsing chamber, the stream of liquid injected from the liquid supply source being adapted to rinse residual particles of said flowable material from said post-dispensing vessel.

21. The apparatus of claim 19 in which the post-dispensing vessel comprises a mixing chamber, the injected liquid being adapted to mix with the flowable material as it is introduced into the mixing chamber.

22. The apparatus of claim 19 in which the liquid supply source is adapted to relieve an accumulation of vacuum pressure, whereby reverse aspiration of liquid back to the liquid supply source is avoided.

23. A system for dispensing a predetermined amount of flowable material over a predetermined time interval into a dispensing destination, said system comprising:
a system cabinet;
at least one dispensing unit, each dispensing unit comprising:
a supply reservoir for storing a quantity of flowable material;
a metering wheel member for conveying predetermined amounts of flowable material,
an agitator assembly for stirring flowable material within the supply reservoir,
a dispensing port through which flowable material carried by the metering wheel is dispensed from the dispensing unit, and
a motive power source for rotating the metering wheel at a predetermined rate and actuating the agitator assembly;
a post-dispensing vessel; and
a liquid supply source,
the dispensing port being in communication with the post-dispensing vessel to convey dispensed flowable material thereto, whereby the flowable material is adapted to be dispensed by the system to the dispensing destination, the liquid supply source being operatively connected to the post-dispensing vessel, the liquid supply source being adapted to inject a stream of liquid into the post-dispensing vessel, the at least one dispensing unit, post-dispensing vessel and liquid supply source all being housed in the system cabinet.

24. The system of claim 23 in which the post-dispensing vessel comprises a rinsing chamber, the stream of liquid injected from the liquid supply source being adapted to rinse residual particles of said flowable material from said post-dispensing vessel.

25. The system of claim 23 in which the post-dispensing vessel comprises a mixing chamber, the injected liquid being adapted to mix with the flowable material as it is introduced into the mixing chamber.

26. The system of claim 23 in which the liquid supply source is adapted to relieve an accumulation of vacuum pressure, whereby reverse aspiration of liquid back to the liquid supply source is avoided.

27. The system of claim 23 in which the system cabinet is provided with lockable shutter members, whereby unauthorized access to the system is prevented.

28. A system for dispensing a predetermined amount of flowable material over a predetermined time interval into a dispensing destination, said system comprising:
a plurality of dispensing units, each dispensing unit comprising:
a supply reservoir for storing a quantity of flowable material;
a metering wheel member for conveying predetermined amounts of flowable material,
an agitator assembly for stirring flowable material within the supply reservoir,
a dispensing port through which flowable material carried by the metering wheel is dispensed from the dispensing unit, and
a motive power source for rotating the metering wheel at a predetermined rate and actuating the agitator assembly; and
a post-dispensing vessel;
the dispensing port of each dispensing unit being in communication with the post-dispensing vessel to convey dispensed flowable material thereto, the post-dispensing vessel comprising a mixing chamber for mixing the flowable material dispensed by each dispensing unit, whereby the flowable material is adapted to be dispensed by the system to the dispensing destination.

29. The system of claim 28 in which the supply reservoir in each dispensing unit contains a different flowable material.
